(19) United States
(12) Patent Application Publication
(10) Pub. No.: US 2018/0130490 A1
(43) Pub. Date: May 10, 2018

(54) OPTICAL DISK DEVICE, OPTICAL-DISK CHECKING METHOD AND OPTICAL-DISK CHECKING PROGRAM

(71) Applicant: Panasonic Intellectual Property Management Co., Ltd., Osaka (JP)

(72) Inventors: Yoshihisa TAKAHASHI, Osaka (JP); Daisuke SHIMODA, Osaka (JP); Masaru KAIDA, Osaka (JP); Motoshi ITO, Osaka (JP)

(21) Appl. No.: 15/789,968

(22) Filed: Oct. 21, 2017

(30) Foreign Application Priority Data
Nov. 4, 2016 (JP) 2016-215771

(51) Int. Cl. G11B 17/08; G11B 23/04

(52) U.S. Cl. CPC G11B 17/08; G11B 23/04

(57) ABSTRACT

A conventional checking method—in which all of the optical disks are selected one by one from the plurality of optical disks stacked in a thickness direction and accommodated in a magazine—takes lots of time for checking. To solve the problem above, the optical disk device has a magazine, a disk drive, and a disk carrier device. The magazine accommodates a plurality of optical disks stacked in the thickness direction of the optical disks. The disk drive checks at least a recording surface facing an inner wall of the magazine of any optical disk of the optical disks accommodated in the magazine. Of the plurality of optical disks stacked and accommodated in the magazine, the disk carrier device takes out an optical disk positioned at an end in the thickness direction and whose recording surface faces the inner wall of the magazine, and carries it to the disk drive.

### BACKGROUND

### 1. Technical Field

The present disclosure relates to an optical disk device, an optical-disk checking method and an optical-disk checking program for checking optical disks.

### 2. Description of the Related Art

Patent Literature 1 discloses the following disk device. The disk device performs test recording on a recordable optical disk by laser power and reproduces the test recording. Evaluating the reproduced result, the disk device determines an appropriate driving speed of the recordable optical disk. This allows a recordable optical disk to have error-minimized recording.

### CITATION LIST

### Patent Literature

PTL 1: Japanese Unexamined Patent Application Publication No. 2001-067672

### SUMMARY

### Technical Problem

If an optical disk has foreign matters or a flaw on the recording surface, data-recording to the disk and data-readout from the disk often fails.

To avoid such a problem, optical disks are checked in advance whether data-recording and data-readout is successfully performed or not. However, checking operation on many disks takes lot of time.

To solve the problem above, the present disclosure provides an optical disk device, an optical-disk checking method, and an optical-disk checking program capable of efficiently checking optical disks.

### Solution to Problem

The optical disk device of the present disclosure has a magazine, a disk drive, and a disk carrier device. The magazine accommodates a plurality of optical disks stacked one on another in the thickness direction of the optical disks. Of the optical disks accommodated in the magazine, the disk drive checks at least a recording surface of any optical disk whose recording surface faces the inner wall of the magazine. Of the optical disks stacked one on another and accommodated in the magazine, the disk carrier device carries an optical disk that is positioned at the end in the thickness direction and its recording surface faces the inner wall of the magazine to the disk drive.

The optical device of the present disclosure has a plurality of disk drives, a plurality of magazines, a magazine rack, and a disk carrier device. Each of the disk drives performs data-recording or data-readout on any of a plurality of optical disks. Each of the magazines accommodates the optical disks stacked in the thickness direction of the optical disks. The magazine rack accommodates the magazines. The disk carrier device selects any of the magazines from the magazine rack, selects any optical disk from the optical disks accommodated in the selected magazine, and carries the selected optical disk to any of the disk drives. Of the optical disks stacked and accommodated in the selected magazine, an optical disk positioned at the end in the thickness direction and whose recording surface faces the inner wall of the magazine is carried to any of the disk drives by the disk carrier device. Any of the disk drives checks the recording surface of the optical disk carried by the disk carrier device. The disk carrier device carries another optical disk accommodated in one magazine to another disk drive, while any of the disk drives is checking any of the optical disks.

### ADVANTAGEOUS EFFECT OF INVENTION

The optical disk device, the optical-disk checking method, and the optical-disk checking program of the present disclosure are capable of efficiently checking many optical disks.

### BRIEF DESCRIPTION OF THE DRAWINGS

FIG. 1 shows a state where a plurality of optical disks is stacked one on another in the thickness direction of the optical disks;

FIG. 2 shows a state where a plurality of optical disks stacked one on another in the thickness direction is accommodated in a magazine;

FIG. 3 shows the structure of the disk device;

FIG. 4 is a flowchart showing the checking process on the optical disks;

FIG. 5 is a flowchart showing the process when an optical disk does not meet a predetermined criterion for judgement in the checking process; and

FIG. 6 is a time chart for enhancing efficiency of the checking process and the workings of the disk carrier device.

### DETAILED DESCRIPTION

Hereinafter, an exemplary embodiment will be described in detail, with reference to the accompanying drawings. However, details beyond necessity (for, example, descriptions on well-known matters or on substantially identical structures) may be omitted to eliminate redundancy from the description below for easy understanding of those skilled in the art.

It is to be understood that the inventor(s) provides the accompanying drawings and the description below for purposes of full understanding of those skilled in the art and they are not to be construed as limitation on the scope of the claimed disclosure.

### First Exemplary Embodiment

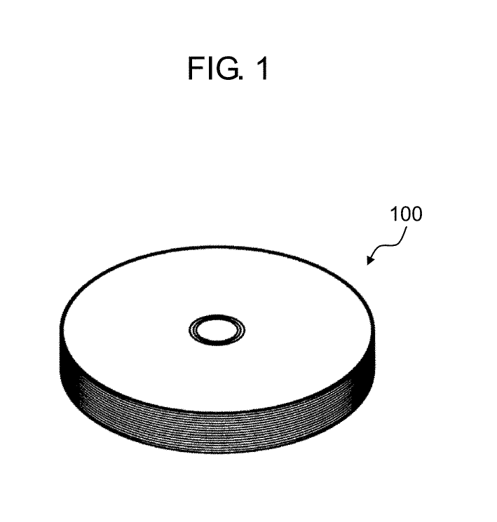

FIG. 1 shows a state where a plurality of optical disks is stacked one on another in the thickness direction of the optical disks. As shown in FIG. 1, optical disks 100 are stacked one on another in the thickness direction (i.e., in a direction perpendicular to the recording surfaces of optical disks 100).

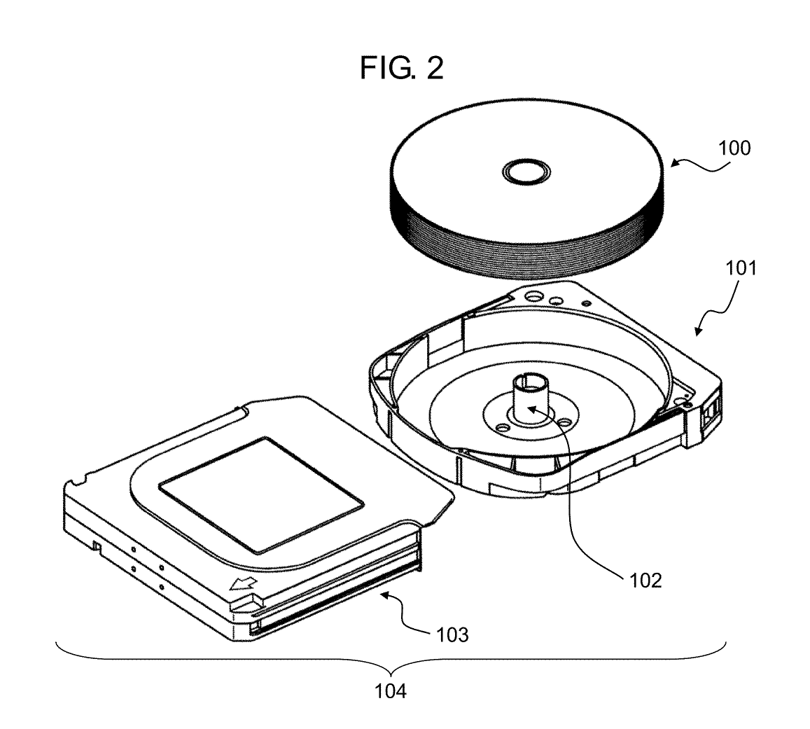

FIG. 2 shows a state where a plurality of optical disks stacked one on another in the thickness direction is accommodated in the magazine. A plurality of optical disks 100 stacked one on another in the thickness direction is accommodated in magazine tray 101. Magazine tray 101 has center pillar 102. Center pillar 102 is inserted through the center hole of each disk of optical disks 100, by which optical disks 100 are retained so as not to move in the plane direction of them. Magazine tray 101, which retains optical disks 100 stacked one on another in the thickness direction, is accommodated in tray holder 103. Magazine tray 101 and tray holder 103 form magazine 104.

As shown in the figure, when magazine 104 retains optical disks 100 (stacked one on another in the thickness direction) such that the thickness direction of optical disks 100 agrees with the vertical direction, optical disks 100 are retained by center pillar 102. At that time, the disk at the very bottom of the stacked structure of optical disks 100 bears the total weight of optical disks 100 as a load.

The load can cause distortion in the disk at the bottom of the stacked structure of optical disks 100. Further, the bottom disk is closer to the bottom surface of magazine tray 101 than other optical disks positioned above in stacked optical disks 100. That is, compared to other disks positioned above, the recording surface of the bottom disk is likely to collect dust attached on the inner bottom surface of magazine tray 101.

Besides, if magazine tray 101 bends downward due to the aforementioned load, the recording surface of the bottom disk comes in contact with the inner bottom surface of magazine tray 101, which can cause, for example, a flaw on the recording surface.

Such an unwanted event happens not only in the bottom disk of the stacked optical disks 100; it can also happen between the disk positioned at the top of stacked optical disks 100 and the inner top surface of magazine 104 (i.e., tray holder 103).

Considering above, the bottom disk of stacked optical disks 100 is at a risk of unsuccessful data-recording and data-readout higher than other disks in the stacked structure of optical disks 100. In other words, it means that, if a disk other than the bottom disk of optical disks 100 fails to record data and to read out data, the risk of unsuccessful data-recording and data-readout becomes high in the bottom disk.

In view of the tendency described above, the structure of the exemplary embodiment checks optical disks 100.

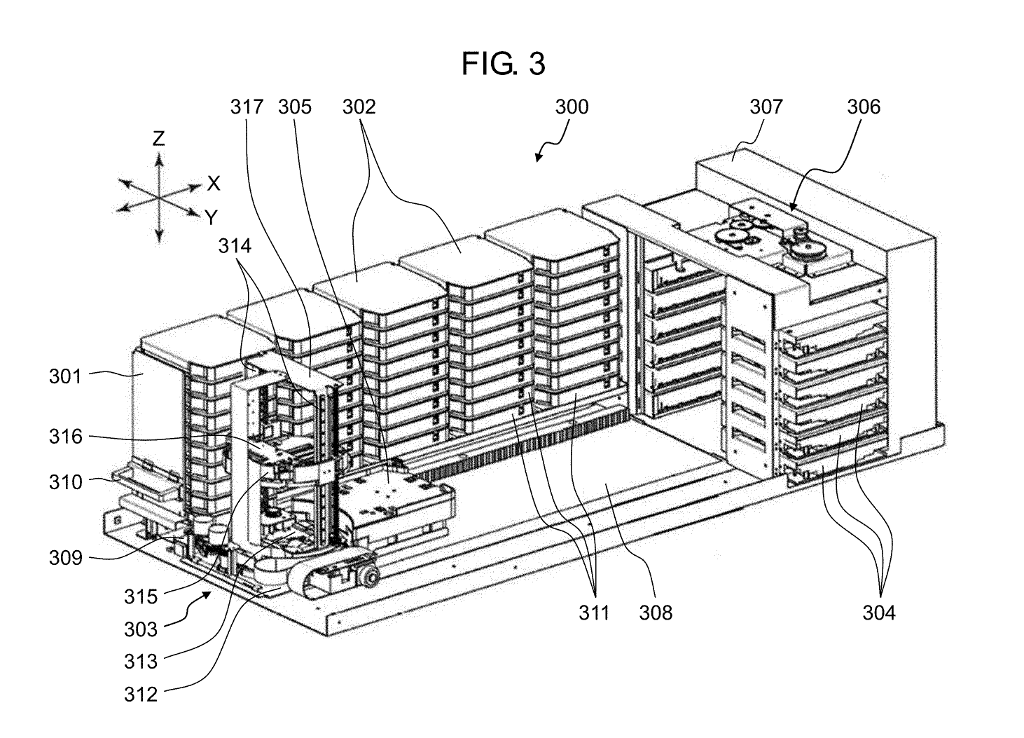

FIG. 3 shows the structure of the disk device. In the description of the exemplary embodiment, the lower left in FIG. 3 will be referred to the front of the device and the upper right in FIG. 3 will be referred to the rear of the device.

Optical disk device 300 of the embodiment has two magazine stockers 301. Two magazine stockers 301 are disposed opposite to each other on bottom chassis 308 in the Y direction of the width of the device. In FIG. 3, one of them (disposed in the near side) is not shown. The top plate and the divider plate of magazine stocker 301 are also omitted in FIG. 3.

Magazine stocker 301 accommodates a plurality of magazine stacks 302. Each of magazine stacks 302 has magazine 311 that accommodates two-or-more disks (for example, 12 disks). Picker 303 is disposed between the two magazine stockers 301. Picker 303 draws out magazine 311 from magazine stack 302 and retains magazine 311.

Picker 303 carries magazine 311 retained on it to a place close to a plurality of disk drives 304 disposed at the rear of the device. Picker 303 has integrally formed lifter 305 that pushes disks out of magazine 311.

Magazine 311 (shown in FIG. 3) is identical to magazine 104 (shown in FIG. 2) which includes magazine tray 101 and tray holder 103. This tray holder 103 is removed from magazine 311 when magazine 311 is carried by a disk carrier device after drawn out from magazine stack 302. Hereinafter, such magazine 311 without tray holder 103 is also referred to as magazine 311.

Disk drive 304 performs data-recording or data-reproducing on a disk. Disk drive 304 is a tray-type disk drive in which a disk is loaded by a tray. A plurality of disk drives 304, which is stacked up in the Z direction along the height of the device, is disposed adjacent to each of magazine stockers 301 in the rear of the device. Carrier 306 is disposed between stacked-up disk drives 304 disposed adjacent to magazine stocker 301 on one side and stacked-up disk drives 304 disposed adjacent to magazine stocker 301 on the other side.

For example, optical disk device 300 shown in FIG. 3, which will be described below, has six disk drives on each side, i.e., 12 disk drives in total.

Receiving two-or-more disks pushed out by lifter 305, carrier 306 retains them as a pile, separates one disk from the retained disks above a tray taken out of any disk drive 304, and puts the separated disk on the tray.

Electric circuits and power source 307 are disposed in the rear of the device behind carrier 306 and disk drives 304. The electric circuits and power source 307 control the workings (for example, drive a motor) of the devices, such as picker 303, disk drives 304, carrier 306. The electric circuits and power source 307 are connected, for example, to a host computer as a data administrator. In response to instructions from an operator, the host computer issues a command to the electric circuits and power source 307 so as to perform writing/reading of data on certain magazine 311. Receiving the command, the electric circuits and power source 307 control the workings of each device, such as picker 303, disk drives 304, and carrier 306.

Magazine stocker 301 is disposed along guide rail 309 that slidably guides picker 303. Guide rail 309 extends in the X direction of the depth of the device (i.e., in the longitudinal direction of magazine stocker 301). Magazine stocker 301 has handle 310 on its side surface on the front of the device. Pulling handle 310 moves magazine stocker 301 in a direction of the front of the device. Each magazine stocker 301 has a lattice-shaped divider plate (not shown) seen from the Y direction of the width of the device. Magazine stack 302 which includes multiple magazines 311 is accommodated in a space surrounded by the divider plate.

Picker 303 has running base 312. A carriage (not shown) that slides on guide rail 309 is disposed on running base 312 on the side of magazine stocker 301 on one side; similarly, a roller (not shown) is disposed on running base 312 on the side of magazine stocker 301 on the other side.

Rotating table 313 has a pair of elevator rails 314. Elevator rails 314, which are disposed opposite to each other, extend in the Z direction of the height of the device. Elevator table 315 is disposed between elevator rails 314. Rotating table 313 further has a motor (not shown) that generates driving force for moving up/down elevator table 315.

Elevator table 315 has a pair of hooks (not shown) and chuck 316. The hooks engage with an engagement dent of magazine 311. Having a structure that opens/closes the hooks, chuck 316 moves magazine 311 backward and forward. The pair of elevator rails 314 is attached to the both arms of U-shaped angle 317.

The description above introduces an example in which an optical disk is carried from magazine stack 302 accommodated in magazine stocker 301 to disk drive 304 via the following components: picker 303, lifter 305, carrier 306, guide rail 309, running base 312, rotating table 313, elevator rail 314, elevator table 315, and chuck 316. However, the structure of the present disclosure is not limited to the above. An optical disk may be carried from magazine stack 302 to disk drive 304 by other methods. In the description of the embodiment, the structure formed of picker 303, lifter 305, carrier 306, guide rail 309, running base 312, rotating table 313, elevator rail 314, elevator table 315, and chuck 316 is described as the disk carrier device.

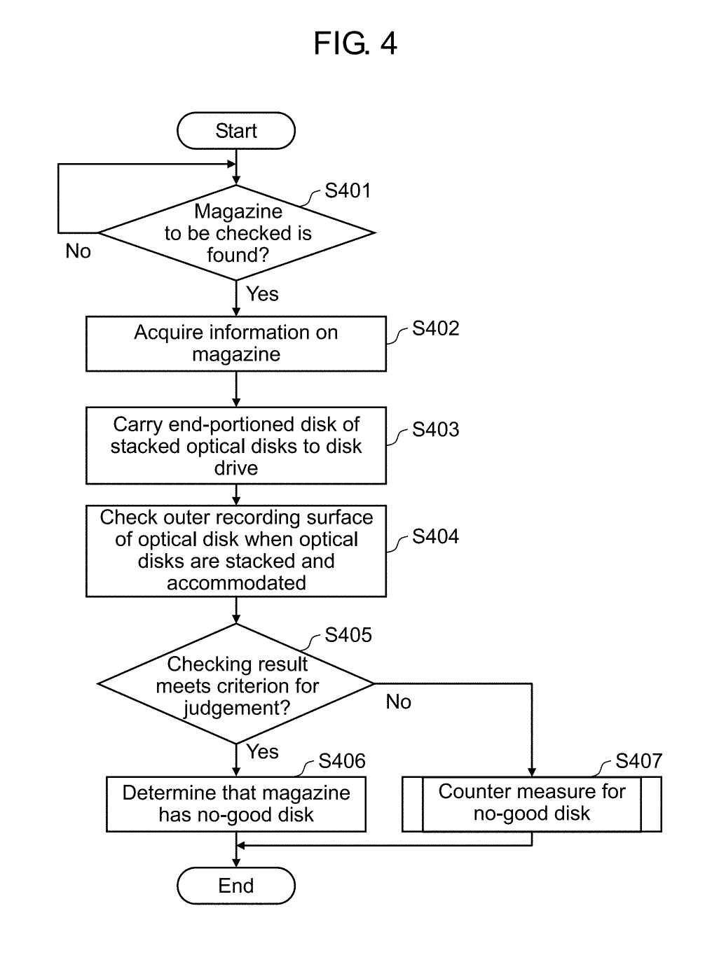

FIG. 4 is a flowchart showing the checking process on the optical disks. The process shown by the flowchart is executed by, for example, optical disk device 300. Specifically, to perform the checking process on optical disks, the disk carrier device and disk drive 304 are controlled by software programmed based on the flowchart above in a calculation integrated circuit of a CPU (Central Processing Unit) disposed in the electric circuits and power source 307 of optical disk device 300.

In step S401, the CPU checks optical disk device 300 for presence or absence of magazine 311 having optical disk 100 to be checked. If the CPU finds magazine 311 to be checked, the CPU moves the procedure to step S402; otherwise, the CPU repeats step S401.

In step S402, the CPU moves the disk carrier device to a position at which magazine 311 to be checked is accommodated. Approaching magazine 311 to be checked, the disk carrier device reads out the information of a bar-code or radio frequency identifier (RFID) attached to magazine 311 by using a bar-code reader (not shown) or an RFID reader (not shown) of the device.

When magazine 311 has a bar-code, the disk carrier device reads information of the bar-code to identify magazine 311 by using the bar-code reader. Optical disk device 300 (i.e., the CPU) acquires the information on magazine 311 from the identification information obtained by the disk carrier device.

The aforementioned information on magazine 311 includes, for example, the followings: information for identifying magazine 311 itself, the number of optical disks 100 accommodated in magazine 311, memory capacity of each optical disk 100, the structure of the recording surface of optical disk 100 (for, example, single-sided recordable optical disk or double-sided recordable optical disk), the number of recording layers for a single side of optical disk 100, and presence or absence of disk failure in an already tested magazine. However, the information on magazine 311 is not limited to the above; it may include information on other magazines.

For example, using a correspondence table, optical disk device 300 (the CPU) acquires the information to identify magazine 311 from the identifying information on magazine 311. The correspondence table may be stored in optical disk device 300 or may be stored in a device to which optical disk device 300 is connected.

When magazine 311 has an RFID, the disk carrier device reads out identifying information on magazine 311 and information on magazine 311 from each RFID attached to magazine 311 by using the RFID reader of the device. As an RFID has a storage capacity greater than a bar-code, information on magazine 311 can be stored in it.

As described earlier, magazine 311 accommodates a plurality of optical disks 100 stacked one on another. In step S403, the CPU controls the disk carrier device so as to take out optical disk 100 disposed at an end of the stacked disks and whose recording surface faces the bottom inner wall of magazine tray 101 or faces the top inner wall of tray holder 103. The optical disk taken out of magazine 311 is carried to disk drive 304.

In magazine 311 (same as magazine 104), since optical disks 100 are stacked one on another, they have a tight (close) contact with each other. That is, dust or other foreign particles are unlikely to get into the stacked disks. In contrast, as for optical disk 100 positioned at an end of the stacked structure, its recording surface has no tight (close) contact with a surface of other optical disk 100; instead, the recording surface comes close to the inner wall of magazine tray 101 or of tray holder 103. If foreign particles such as dust get into magazine 311, they are likely to attach to the recording surface (facing the inner wall of magazine 311) of optical disk 100 positioned at the end of the stacked disks.

Besides, optical disk 100 positioned at an end can make contact with the inner wall of magazine 311 due to shaking caused in transportation of magazine 311. Such unwanted contact can cause distortion in shape or a flaw on the recording surface of the disk close to the inner wall of magazine 311.

From the reason above, prior to checking optical disks 100 accommodated in magazine 311, optical disk device 300 of the exemplary embodiment defines checking priority in optical disks 100, according to the accommodation state in magazine 311. According to the priority, optical disk device 300 determines optical disk 100 to be carried from magazine 311 to disk drive 304.

When each of optical disks 100 accommodated in magazine 311 is a single-sided recordable optical disk and they are stacked such that each recording surface faces in the same direction, the checking target is the recording surface of optical disk 100 positioned at the upper end or the lower end of magazine 311. When each of optical disks 100 accommodated in magazine 311 is a double-sided recordable optical disk, the checking target is the upper recording surface of optical disk 100 positioned at the upper end and the lower recording surface of optical disk 100 positioned at the lower end of magazine 311.

That is, when optical disk 100 is a double-sided recordable optical disk, optical disk device 300 gives the highest priority to the optical disks positioned at the both ends. When optical disk 100 is a single-sided recordable optical disk, optical disk device 300 gives the highest priority to the optical disk positioned at an end whose recording surface faces the inner wall of magazine 311 has the highest priority.

The structure of the recording surface (i.e., a single-sided medium or a double-sided medium) can be identified from the magazine information read out in step S402. Optical disk device 300 (the CPU) may define the priority for each optical disk 100 based on not only the position of optical disk 100 in the stacking state but also information on magazine 311.

In step S404, disk drive 304 checks optical disk 100 taken out of magazine 311 by the disk carrier device. According to the information on magazine 311 acquired in step S402; particularly, based on the structure of the recording surface (i.e., a single-sided or a double-sided), disk drive 304 determines the recording surface to be checked.

When optical disk 100 is a double-sided recordable optical disk, at least the recording surface close to the inner wall of magazine 311 has to be checked. If the both recording surfaces can be checked substantially at the same time and the both-side checking takes not so longer than the single-side checking, it is preferable that the both recording surfaces should be checked substantially together.

Compared to the case where the opposite surface needs to be checked according to the checking result of the recording surface close to the inner wall of magazine 311, the both-side checking at the same time shortens the checking time.

When optical disk 100 has a plurality of recording layers in the recording surface on one side, it is preferable that the outermost layer (on the surface side) should be primarily checked. This is because that the surface layer is likely to have dust or a flaw, and if distortion occurs in the disk, the surface layer is most susceptible to the effect. Besides, in an optical point of view, the checking focused on the surface layer contributes to an easy determination at a level of signal processing, for example, signal-to-noise ratio.

As the aforementioned optical checking is a common knowledge of one skilled in the art, the specific description on the optical checking by disk drive 304 will be omitted in the present disclosure.

In step S405, optical disk device 300 (the CPU) makes a comparison between the checking result obtained by disk drive 304 and a predetermined criterion for determining good or no-good. If the checking result satisfies the criterion, optical disk device 300 (the CPU) moves the procedure to step S406; otherwise, the procedure goes to step S407.

When optical disk 100 is a double-sided recordable optical disk, two optical disks to be checked have been carried from magazine 311 to disk drive 304 in step S403. In step S405, if both of the two disks satisfy the criterion, optical disk device 300 (the CPU) moves the procedure to step S406. If any of the two disks does not satisfy the criterion, the procedure goes to step S407.

In step S406, optical disk device 300 (the CPU) determines that magazine 311 containing optical disks 100 checked in step S403 has no problem. That is, the CPU has the conclusion above by estimating that other optical disks 100 without checking also have no problem.

As described above, optical disk device 300 (the CPU) makes decisions by checking optical disk 100 with high priority; other disks in the same magazine have no actual checking. As a result, optical disk device 300 performs checking with efficiency.

In step S407, optical disk device 300 (the CPU) performs a defective-disk routine on a disk that does not satisfy the predetermined criterion.

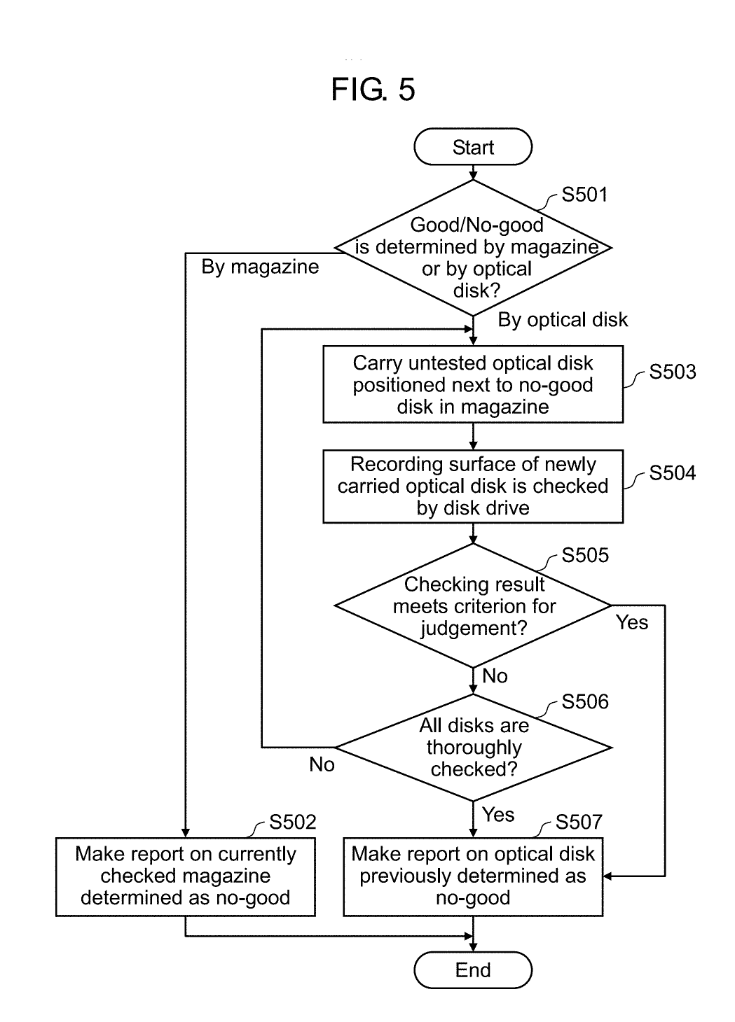

The specific procedure of the defective-disk routine will be described with reference to FIG. 5. FIG. 5 is a flowchart showing the procedure for a disk that has been determined to be substandard in the checking process.

In step S501, optical disk device 300 (the CPU) determines whether it performs the checking by magazine 311 or by optical disk 100. The determination above, for example, may be done in advance by the user of optical disk device 300 or the manufacturer-supplied default setting of the device may be used. If the checking is performed by magazine 311, optical disk device 300 (the CPU) moves the procedure to step S502. If the checking is performed by optical disk 100, the CPU moves the procedure to step S503.

The process in step S502 is for the case where the checking is performed by magazine 311. Optical disk device 300 (the CPU) has already determined in aforementioned step S405 that the disk as a checking target does not satisfy the criterion. Therefore, in step S502, the CPU performs necessary output operation, for example, makes a user report that shows magazine 311 as a checking target has been determined to be no-good.

The process in step S503 is for the case where the checking is performed by optical disk 100. Optical disk device 300 (the CPU) newly gives the checking priority to optical disk 100 stacked next to the disk that has been determined to be no-good in step S405. After that, optical disk device 300 (the CPU) makes instructions to the disk carrier device so that priority-applied optical disk 100 is taken out of magazine 311 and carried to disk drive 304.

Optical disk device 300 described in FIG. 3 of the exemplary embodiment has a plurality of disk drives 304. Optical disk device 300 may check the optical disk to be newly checked in a disk drive different from the disk drive that has been used for previous checking.

However, suppose that optical disk device 300 has a single disk drive or even when the device has two or more disk drives, they are not available because of being in operation. In that case, prior to checking in step S504, optical disk device 300 takes optical disk 100 that has been determined to be no-good in step S405 out of disk drive 304 and put it back to original magazine 311. After that, optical disk device 300 takes optical disk 100 to be newly checked out of magazine 311 and carry it to disk drive 304.

In step S504, disk drive 304 checks the recording surface of the disk in the similar manner performed in step S404.

In step S505, as is the similar manner in step S405, optical disk device 300 (the CPU) makes a comparison between the checking result of optical disk 100 and a predetermined criterion. If the checking result meets the criterion, optical disk device 300 (the CPU) moves the procedure to step S507; otherwise, the procedure goes to step S506.

In step S506, optical disk device 300 (the CPU) determines whether optical disks 100 accommodated in magazine 311 have been thoroughly checked or not. If all of optical disks 100 complete checking, optical disk device 300 (the CPU) moves the procedure to step S507.

In step S507, optical disk device 300 (the CPU) performs necessary output operation, for example, makes a user report that shows optical disk 100 that has been determined to be no-good in the previously performed checking. The report from the device allows the user to have countermeasures, for example, removing a no-good disk or avoiding use of it.

For example, as described in step S402, a bar-code or an RFID may be attached to magazine 311. In that case, in addition to the output of the user report, optical disk device 300 updates information relating to the bar-code or the RFID in step S502 and step S507.

Specifically, when magazine 311 has a bar-code, optical disk device 300 (the CPU) accesses the information on magazine 311 according to the identification information on magazine 311 read out of the bar-code. After that, optical disk device 300 adds information indicating no-good magazine 311 or no-good optical disk 100 contained in magazine 311, or updates the information.

When magazine 311 has an RFID, optical disk device 300 (the CPU) controls the disk carrier device so as to access to the RFID of magazine 311 for writing or updating the information in a similar manner above. That is, once magazine 311 undergoes the checking process, the RFID stores the checking result, by which a wasteful operation, for example, repeatedly-performed checking on the same magazine, can be avoided.

FIG. 5 illustrates the checking process for optical disk 100 as a single-sided recordable optical disk. As described in step S404 and step S405, when optical disk 100 is a double-sided recordable optical disk, there is another angle to be considered.

Of optical disks 100 stacked and accommodated in magazine 311 in step S405, for example, suppose that both of the two disks positioned at the ends (i.e., at the top and the bottom) are determined to be no-good as the checking result. In that case, two disks positioned next to the top one and the bottom one need the processes of steps S504 and S505.

As described above, the optical disk drive of the exemplary embodiment has a magazine, a disk carrier device, and a disk drive. The magazine accommodates a plurality of optical disks stacked in the thickness direction. The disk carrier device takes an optical disk—positioned at an end in the stacking direction (i.e., in the direction of the thickness of the stacked optical disks) and whose recording surface faces the inner wall of the magazine—out of the optical disks accommodated in the magazine. Receiving the optical disk taken out by the disk carrier device, the disk drive checks the disk at least its recording surface that faces the inner wall of the magazine.

Of a plurality of optical disks accommodated in a magazine, the optical disk device primarily checks an optical disk with a high risk of defectiveness. This allows the optical disks accommodated in a magazine to be checked with efficiency.

The optical disk above may be a single-sided recordable optical disk or may be a double-sided recordable optical disk. As for the single-sided recordable optical disk, the disk carrier device takes out a single optical disk—whose recording surface faces the inner wall of the magazine—from the magazine. As for the double-sided recordable optical disk, the disk carrier device takes out two optical disks—whose recording surfaces face the inner wall of the magazine—from the magazine. In this way, the optical disk device performs efficient checking on aforementioned both types of optical disks.

When an optical disk has a plurality of recording layers on the recording surface, it is preferable that the disk drive should check at least the recording layer closest to the surface. This is because that the surface layer is likely to have dust, a blot, or a scratch, and if distortion occurs in the disk, the surface layer is likely to have a serious effect. Checking the disk on the surface side leads to an easy determination of good or no-good.

When an optical disk positioned at an end of the stacked structure of optical disks accommodated in a magazine is determined to be no-good as a result of checking, the next checking target is the disk positioned on the side inner than the no-good disk in the thickness direction. Particularly, it is preferable that the optical disk device should check the optical disk positioned next to the no-good disk.

With the structure above, the optical disk device performs efficient checking on the optical disks accommodated in a magazine. In consideration of defectiveness that tends to develop from the end of the stacked disks toward the inner side, the optical disk device starts the checking in the order of the disk with the highest risk of occurrence of defectiveness. This allows the device to easily find a susceptible range in the stacked disks. In the checking started from the end toward the inner side, upon finding a good disk, the device can stop the checking operation.

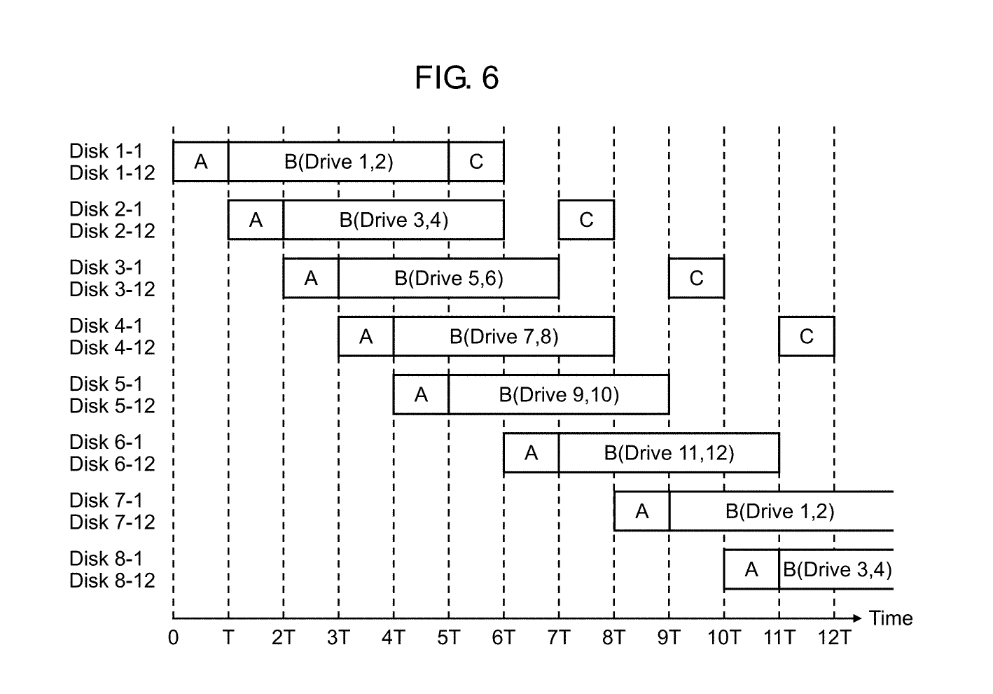

FIG. 6 is a time chart for enhancing efficiency of the checking process and the workings of the disk carrier device. The checking process described in FIG. 6 is performed, for example, by optical disk device 300 having a plurality of magazines 311 and a plurality of disk drives 304 shown in FIG. 3.

In FIG. 6, the vertical axis of the chart shows information on a magazine to be checked and the position of a disk in a magazine. Specifically, ‘disk 1-1’ of the vertical axis represents the first (top-positioned) disk in magazine 1; similarly, ‘disk 1-12’ represents the 12th (bottom-positioned) disk in magazine 1. FIG. 3 shows an example where magazine 311 accommodates 12 optical disks 100, and therefore, the 12th disk is positioned at the bottom.

The horizontal axis of the time chart shown in FIG. 6 represents time (shown by ‘T’ for short).

In the time chart of FIG. 6, ‘A’ represents the processing time required for the disk carrier device from taking out optical disk 100 to be checked from magazine 311 accommodated in magazine stocker 301 to carrying it to disk drive 304. In FIG. 6, the process needs “1T”.

In the time chart of FIG. 6, ‘B’ represents the processing time required for disk drive 304 to check received optical disk 100. The example of the embodiment describes that the process needs “4T”. FIG. 3 shows optical disk device 300 having 12 disk drives 304. FIG. 6 specifies disk drives 304 to be used for checking. For example, ‘B (Drive 1, 2)’ means that the first and the second disk drives 304 are used for the checking operation.

According to optical disk device 300 of FIG. 3, optical disks 100 accommodated in the same magazine 311 are carried to disk drive 304 in the same carrying operation; therefore, it is described as a concurrently performed process.

In the time chart of FIG. 6, ‘C’ represents the processing time for the disk carrier device to return checked optical disk 100 to magazine 311 from disk drive 304. FIG. 6 shows that the process needs “1T”.

The time chart of FIG. 6 shows an example where each processing time is uniformly defined, such as 1T for ‘A’, 4T for ‘B’, and 1T for ‘C’. In reality, however, the processing time for ‘A’ has case-by-case difference, for example, depending on the distance and the carrying route between magazine 311 and disk drive 304. The processing time for ‘B’ depends on a condition of optical disk 100 to be checked, for example, it is good or no-good. The processing time for ‘C’, as is similar in the case of ‘A’, depends on the distance and the carrying route between magazine 311 and disk drive 304. In this way, each processing time varies on a case-by-case basis. It would be understood that the structure of the present disclosure merely shows a simplified model in which the time required for each process is uniformly defined for the sake of easy understanding.

At first, optical disk device 300 (the CPU) gives instructions to the disk carrier device so as to take out top-positioned optical disk 100 and bottom-positioned optical disk 100 from first magazine 311 and carry them to first and second disk drive 304 respectively. Receiving the instructions, the disk carrier device takes out the first (the top-positioned) disk and the 12th (the bottom-positioned) disk from first magazine 311 and carries them to first disk drive 304 and second disk drive 304 respectively.

Receiving the first (the top-positioned) disk and the 12th (the bottom-positioned) disk, first disk drive 304 and second disk drive 304 perform the checking operation on each disk.

While first and second disk drives 304 are checking each disk, optical disk device 300 (the CPU) gives instructions to the disk carrier device so as to take out the first (the top-positioned) disk and the 12th (the bottom-positioned) disk from second magazine 311 and carry them to third and fourth disk drive 304 respectively. Receiving the first disk and the 12th disk, third disk drive 304 and fourth disk drive 304 perform the checking operation on each disk. In this way, the device performs the checking operation, repeating the procedures above.

According to optical disk device 300 of the present disclosure, upon receiving optical disk 100 to be checked, each disk drive 304 starts the checking operation. This is different from a checking way that, waiting until all of disk drives 304 have received each optical disk 100 to be checked, they start checking at the same time. That is, in the checking operation of the present disclosure, the carrying process and the checking process of the disks are concurrently performed. As a result, the structure shortens the processing time for checking operation as totally required for optical disk device 300.

That is, while any one of disk drives 304 is checking optical disk 100 carried from any one of magazines 311, optical disk device 300 gives instructions to the disk carrier device so as to carry optical disk 100 from the same or different one of magazines 311 to another one of disk drives 304. Such a concurrently performed operation allows optical disk device 300 to have an efficient checking process in a short time.

In the checking operation described above, desirable effect can be obtained by improvement in structure conditions. An example is in the case where the ratio of the time required for carrying disks to the time required for checking disks by disk drives 304 is greater than the predetermined value. A further example is in the case where the number of available disk drives 304 is a predetermined value.

It is preferable that the disk carrier device should alternately repeat the disk-returning action (when checked optical disk 100 is carried back to magazine 311) and the disk-carrying action (when optical disk 100 to be checked is carried to disk drive 304 from magazine 311). By virtue of the structure, the disk carrier device always has optical disk 100 thereon whenever it travels between the magazine rack (magazine stocker) and disk drive 304, carrying disks with efficiency with no wasted motion. As shown in FIG. 6, the disk carrier device alternately performs process ‘A’ and process ‘C’ in from ‘4T’. However, the disk-returning action (where optical disk 100 is put back to magazine 311) and the disk-carrying action (where optical disk 100 is carried to disk drive 304) are not necessarily performed on an alternate basis. Even so, compared to the aforementioned another checking way that, waiting until all of disk drives 304 have received each optical disk 100 to be checked, they start checking at the same time, the structure of the embodiment apparently shortens the processing time for the checking operation.

FIG. 6 shows an example in which two optical disks 100 (the first and the 12th) of magazine 311, but the structure of the present disclosure is not limited to. When the checking target is either one of the first or the 12th of optical disks 100 because of a single-sided recordable optical disk, the disk carrier device may take out single optical disk 100 from single magazine 311.

Further, although FIG. 3 and FIG. 6 show an example in which single magazine 311 accommodates 12 optical disks 100, it is not limited to; the number of optical disks 100 accommodated in magazine 311 may be smaller than 12 or may be greater than 12. The structure of the present disclosure has no limitation in the number of disks accommodated in a magazine as long as it accommodates a plurality of optical disk 100 stacked one on another.

The exemplary embodiment describes an example in which optical disks 100 are stacked in a direction that agrees with the vertical direction, but it is not limited to; for example, the thickness direction of the disks may agree with the horizontal direction or an oblique direction. The present disclosure has no limitation in directions in which optical disks 100 are stacked.

Although the exemplary embodiment describes an example, as shown in FIG. 1, in which optical disks 100 are stacked one on another in the thickness direction, it is not limited to. For example, each of optical disks 100 may be put on a tray and each tray with a disk may be stacked in the thickness direction. In this case, too, it is preferable that the checking operation should start from the disk positioned at the end of the stacked optical disks. Even when optical disk 100 is put on the tray, the recording surface of the disk facing the inner wall of magazine 311 is likely to have dust and a scratch, compared to those of other disks.

### Other Exemplary Embodiments

The exemplary embodiment has been described as an example of technique of the present disclosure. However, the technique of the present disclosure is not limited to the structure described above but is applicable exemplary embodiments with various changes, replacement, addition, and omission. Further, a newly exemplary embodiment can be structured by combining the components described in the embodiment above.

Hereinafter, other exemplary embodiments will be described.

The exemplary embodiment above has described the structure mainly relating to optical disk device 300, which is to be disclosed in the present disclosure. However, it is not limited to the exemplary embodiment described above. The structure described above can be applicable to an optical-disk checking method using optical disk device 300. In that case, the checking method is formed by each step of the flowchart described in FIG. 4 and FIG. 5.

The structure described above is also applicable to software program executed by the CPU of optical disk device 300. In that case, too, as is in the checking method above, such a program is designed, based on the flowcharts described in FIG. 4 and FIG. 5.

The structure of the embodiment has been described in detail as an example of the technique of the present disclosure with reference to accompanying drawings.

In addition to a component essential for solving problems, the accompanying drawings and the in-detail description can contain a component used for illustrative purpose in the technique but not essential for solving problems. It will be understood that not all the components described in the drawings and description are essential for solving problems.

Further, it will be understood that the aforementioned embodiments are merely an example of the technique of the present disclosure. That is, the technique of the present disclosure is not limited to the structure described above, allowing modification, replacement, addition, and omission without departing from the sprit and scope of the claimed disclosure.

### INDUSTRIAL APPLICABILITY

The structure of the present disclosure is useful for the field relating to optical disks, for example, an optical disk device, an optical-disk checking method, an optical-disk checking program.

### REFERENCE MARKS IN THE DRAWINGS

100: optical disk
101: magazine tray
102: center pillar
103: tray holder
104: magazine
300: optical disk device
301: magazine stocker
302: magazine stack
303: picker
304: disk drive
305: lifter
306: carrier
307: electric circuits and power source
308: bottom chassis
309: guide rail
310: handle
311: magazine
312: running base
313: rotating table
314: elevator rail
315: elevator table
316: chuck
317: angle

What is claimed is:

1. An optical disk device comprising:
a magazine that accommodates a plurality of optical disks stacked in a thickness direction of the optical disks;
a disk drive that checks at least a recording surface of any optical disk of the optical disks accommodated in the magazine, the recording surface facing an inner wall of the magazine; and
a disk carrier device that carries an optical disk to the disk drive, the optical disk positioned at an end in the thickness direction and whose recording surface faces the inner wall of the magazine, out of the plurality of optical disks stacked and accommodated in the magazine.

2. The optical disk device according to claim 1,
wherein,
each of the optical disks is a single-sided recordable optical disk, and
the disk carrier device carries, of the plurality of optical disks stacked and accommodated in the magazine, a single optical disk positioned at the end in the thickness direction and whose recording surface faces the inner wall of the magazine to the disk drive from the magazine.

3. The optical disk device according to claim 1,
wherein,
each of the optical disks is a double-sided recordable optical disk, and
the disk carrier device carries, of the plurality of optical disks stacked and accommodated in the magazine, two optical disks positioned at two ends in the thickness direction respectively and whose recording surfaces face the inner wall of the magazine to the disk drive from the magazine.

4. The optical disk device according to claim 1,
wherein, when the recording surface of each of the optical disks has a plurality of recording layers, the disk drive checks at least an outermost recording layer of the recording surface.

5. The optical disk device according to claim 1, wherein, in response to a determination that any of previously checked optical disks is no-good, the disk carrier device carries, of the optical disks stacked and accommodated in the magazine, an untested optical disk positioned adjacent to the optical disk determined as no-good from the magazine to the disk drive, and the disk drive checks the recording surface of the newly received optical disk.

6. An optical disk device comprising:
a plurality of disk drives, each of the disk drives performing data-recording or data-readout on any of a plurality of optical disks;
a plurality of magazines, each of the magazines accommodating the optical disks stacked in a direction of thickness of the optical disks;
a magazine rack that accommodates the plurality of magazines; and
a disk carrier device that selects any of the magazines from the magazine rack, selects any optical disk from the plurality of optical disks accommodated in the selected magazine and carries the selected optical disk to any of the plurality of disk drives,
wherein, of the plurality of optical disks stacked and accommodated in the selected magazine, the disk carrier device carries an optical disk positioned at an end in the thickness direction and whose recording surface faces an inner wall of the magazine to any of the plurality of disk drives, any of the plurality of disk drives checks the recording surface of the optical disk carried by the disk carrier device, and while any of the disk drives is checking any of the optical disks, the disk carrier device carries another optical disk accommodated in one magazine to another disk drive.

7. An optical-disk checking method comprising:
carrying, of a plurality of optical disks stacked in a direction of thickness of the optical disks and accommodated in a magazine, an optical disk positioned at an end in the thickness direction and whose recording surface faces an inner wall of the magazine to a disk drive; and
checking at least the recording surface of the optical disk carried to the disc drive, the recording surface facing an inner wall of the magazine.

8. An optical-disk checking program comprising:
carrying, by a disk carrier device, of a plurality of optical disks stacked in a direction of thickness of the optical disks and accommodated in a magazine, an optical disk positioned at an end in the thickness direction and whose recording surface faces an inner wall of the magazine to a disk drive; and
checking, by the disk drive, at least the recording surface of the optical disk carried by the disk carrier device, the recoding surface facing an inner wall of the magazine.
